(19) United States
(12) Patent Application Publication
(10) Pub. No.: US 2011/0298186 A1
(43) Pub. Date: Dec. 8, 2011

(54) GASKETS HAVING ADDITIONAL SEALING ELEMENT

(75) Inventor: Manfred Klinner, Troisdorf (DE)

(73) Assignee: FEDERAL-MOGIUL SEALING SYSTEMS GMBH, Herdorf (DE)

(21) Appl. No.: 13/201,488

(22) PCT Filed: Oct. 27, 2009
(86) PCT No.: PCT/EP2009/007677

§ 371 Date: Aug. 15, 2011

(30) Foreign Application Priority Data
Feb. 13, 2009 (DE) 10 2009 008 791.5

(51) Int. Cl. F16J 15/06

(52) U.S. Cl. 277/654

(57) ABSTRACT

The present invention pertains to a flat gasket with a stopper function layer, particularly for use in internal combustion engines as a cylinder head gasket, a gasket in the area of the exhaust gas supply or exhaust gas discharge of turbochargers or a gasket in the area of the exhaust gas recirculation, wherein the flat gasket features at least one upstream bead relative to its sealing function with respect to a stopper.

The present invention pertains to a flat gasket, particularly for internal combustion engines, such as, for example, a cylinder head gasket, a gasket in the area of the exhaust gas supply or exhaust gas discharge of turbochargers or a gasket in the area of the exhaust gas recirculation.

Flat gaskets such as, for example, cylinder head gaskets seal combustion chambers, medium ducts such as coolant, lubricant and exhaust gas ducts, as well as screw holes. They transmit forces between the components to be sealed such as, for example, an engine block and a cylinder head and therefore significantly influence the distribution of forces in the overall system. For example, cylinder head gaskets need to produce a gas-tight seal and at the same time reliably seal engine oil and cooling water ducts such that no liquid can escape.

Classical soft flat gaskets may consist, for example, of a spliced carrier sheet, onto which soft material is applied on both sides, for example, by means of rolling. A metallic edging may be provided in order to seal the combustion chambers, medium ducts and screw holes and to protect the soft material from overheating. An impregnation of the soft material surface can prevent swelling due to the contact with the mediums such as, for example, oil, water, anti-freeze or other liquids and gases. So-called viton elements that preferably consist of elastomer materials may be provided in order to achieve a partial increase of the surface pressure in predefined areas such as, e.g., oil pressure bores. The surface pressure deforms the material such that it adapts itself to the surfaces to be sealed. Comparatively high clamping forces are required at low springback properties in order to realize the seal.

If the sealing effect of flat gaskets is subject to stringent requirements, for example, with respect to high pressures of the gas or medium to be sealed or with respect to high temperatures, it is possible to use so-called multilayer or multilayer steel gaskets (MLS-gaskets). Such multilayer steel gaskets consist of two or more sealing function layers, for example, of spring steel or carbon steel sheets that are layered in order to form a flat multilayer steel gasket. In order to reliably seal against gas and mediums, beads on the chambers or ducts/passages increase the local pressure (macroseal), wherein complete or partial elastomer coatings can additionally improve the sealing effect (microseal).

The present invention proposes an improved flat seal, the sealing function of which can be adapted in an application-oriented fashion.

The objective of the present invention is attained with an upstream bead relative to the sealing function of the flat gasket, particularly at least one half bead or full bead.

According to the invention, a flat gasket with one or more stopper function layers is proposed, wherein this flat gasket is intended, in particular, for use in internal combustion engines as a cylinder head gasket, a gasket in the area of the exhaust gas supply or exhaust gas discharge of turbochargers or a gasket in the area of the exhaust gas recirculation. The flat gasket features one or more upstream beads relative to its sealing function with respect to at least one stopper of the one or more stopper function layers. The top and bottom function layers are preferably realized symmetrically.

According to one embodiment, the flat gasket features one or more downstream beads relative to its sealing function with respect to the stopper.

According to one embodiment, the flat gasket consists of a flat multilayer gasket. The flat gasket preferably consists of a flat multilayer steel gasket (flat MLS-gasket).

According to one embodiment, at least one of the upstream beads (50, 55) seals relative to at least one insert component (80) that is provided in at least one sealing surface of an at least two-part component (60, 65) to be sealed, wherein the sealing function of the upstream bead (50, 55) is realized by pressing together the upstream bead (50, 55) and a surface of the insert component (80).

According to one embodiment, the insert component (80) has a variable or constant protrusion or recession or a combination thereof relative to the respective sealing surface of one part of the two-part component (60, 65).

According to one embodiment, the beads consist of full beads and/or half beads.

According to one embodiment, at least one of the parts of the two-part component features a duct that ends in an area of the sealing surface of the respective part. The area, in which the duct ends, corresponds to an area of the flat seal between the sealing area of the upstream bead and the sealing area of the stopper.

Other advantages and characteristics of the present invention are disclosed in the following description of exemplary embodiments that refers to the attached drawings, in which

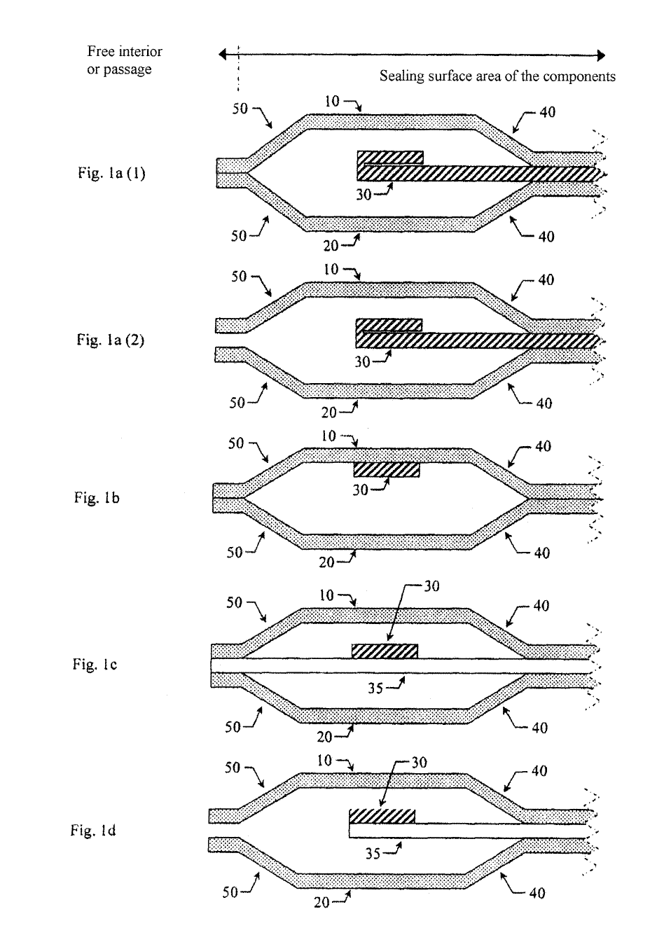

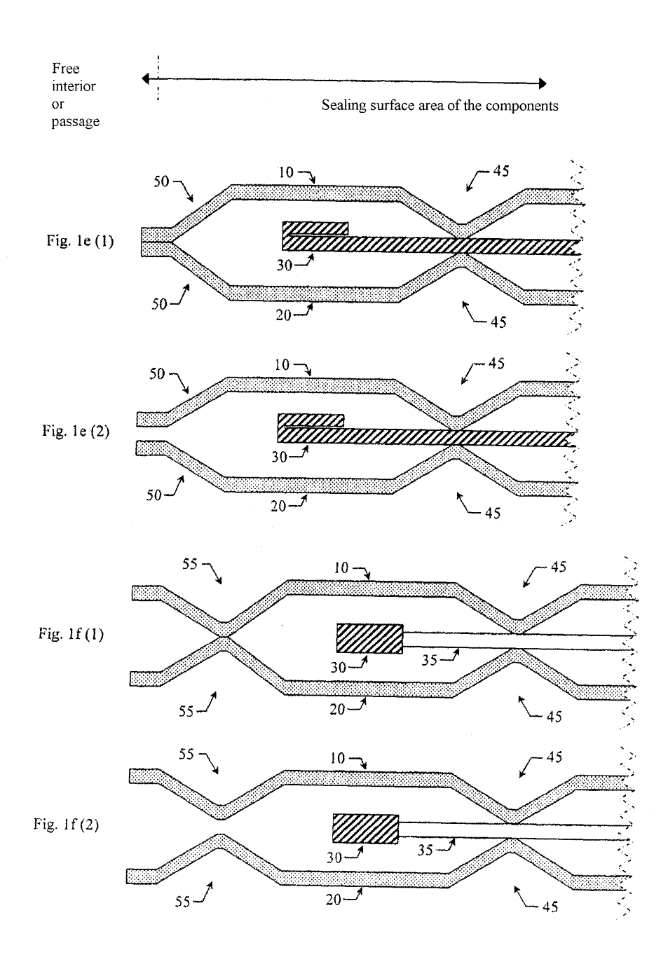

FIGS. 1a to 1f show cross sections through inventive embodiments of a flat gasket;

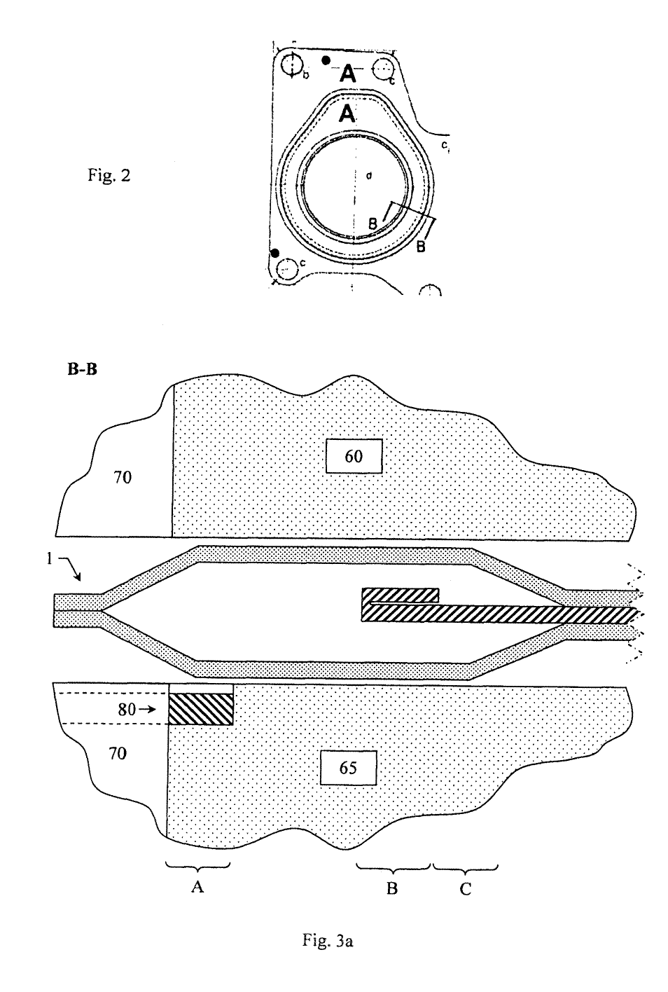

FIG. 2 shows a horizontal projection of a prelative inventive embodiment of a flat gasket, and

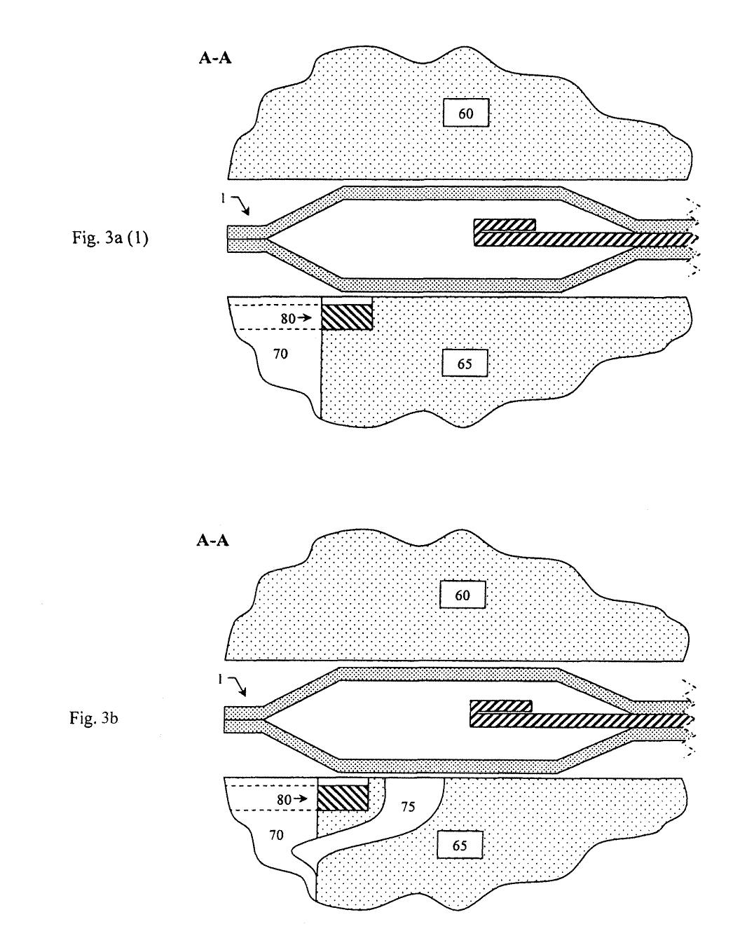

FIGS. 3a and 3b show cross sections through a two-part component with a flat gasket according to an inventive embodiment.

Identical or similar elements are identified by identical or similar reference symbols.

The invention is described below with reference to cylinder head gaskets, particularly multilayer steel cylinder head gaskets (MLS-cylinder head gaskets). However, a person skilled in the art will doubtlessly realize that the characteristics of the invention are not restricted to the field of multilayer steel cylinder head gaskets for internal combustion engines. On the contrary, the characteristics of the invention can also be applied to other flat gaskets that are used, in particular, in the field of internal combustion engines such as, for example, gaskets in the exhaust gas supply and exhaust gas discharge of turbochargers or gaskets in the area of the exhaust gas recirculation. Furthermore, a person skilled in the art will also immediately realize that the characteristics of the invention are not restricted to flat multilayer steel gaskets (flat MLS-gaskets), but can likewise be applied to the field of flat multilayer gaskets. In this respect, flat MLS-gaskets and MLS-cylinder head gaskets respectively represent special designs of flat multilayer gaskets.

Cylinder head gaskets are flat gaskets that seal combustion chambers, coolant and lubricant ducts, as well as mounting leadthroughs (particularly screw leadthroughs), relative to one another under technologically demanding conditions. The cylinder head gasket transmits forces between the cylinder head and the engine block and therefore significantly influences the distribution of forces in the overall engine system. Depending on the respective requirements that are defined by the operating conditions of the engine to be sealed, cylinder head gaskets consist of one or more layers, particularly steel layers. Although up to five layers are currently utilized, this should once again not be interpreted as a restriction. The basic structure of a flat multilayer gasket such as a cylinder head gasket comprises functional layers in the form of a top and a bottom layer.

It is prelative that both functional layers or at least one of these functional layers is beaded, wherein the top and bottom function layers are preferably beaded congruently and preferably consist of steel such as, for example, spring steel or springy special steels. The beads are produced, for example, by means of embossing. In order to ensure the sealing effect of the beads, the top and bottom functional layers need to have a suitable spring characteristic and tensile strength for the intended application in the area of the bead. Due to the elastic properties of the top and bottom functional layers, defined beads generate line pressures in the area of the sealing surfaces of the components to be sealed, for example, in order to seal combustion chambers or medium ducts such as exhaust gas, coolant or lubricant ducts. If a full bead is provided, four individual lines with high line pressure relative to the sealing surfaces of the components to be sealed are formed due to the elastic properties of the top or bottom functional layer that is preferably manufactured from a spring steel sheet while only two individual lines with high line pressure are formed due to the properties of the top or bottom functional layer if a half bead is provided. Full beads are able, for example, to compensate dynamic sealing gap movements and are used, for example, on cylinder head gaskets in order to seal combustion chambers. Since half beads generate lower line pressures than full beads, they are preferably used on cylinder head gasket in order to seal against gas and mediums such as, for example, cooling water and oil, as well as to seal the screw holes, and preferably seal the outer gasket contour. Due to the lower line pressure of the half beads of a cylinder head gasket, the main pressure of the full beads on the combustion chambers is essentially preserved.

A full bead can typically be characterized by a bead depth Y, a side angle X and a head width V. A half bead can typically be characterized by a bead depth Y and a side angle X. In addition to the geometry, the quality, the thickness and the manufacturing process significantly influence the properties of the beads. Due to these factors, it is possible to produce a plurality of different beads that have defined stress and springback properties, but differ significantly with respect to their characteristic or absorption of forces. It would be possible, for example, to realize softer or harder beads. For example, full beads with a small side angle X are softer and have a flatter spring characteristic and a higher continuous fatigue strength.

In addition to beads that generate line pressures in the area of the sealing surfaces of the components to be sealed, it would furthermore be possible to provide so-called stoppers, by means of which an increased surface pressure can be achieved in the area of the sealing surfaces of the components to be sealed. On MLS-cylinder head gaskets, in particular, stoppers are provided in the area of the combustion chamber. The so-called stoppers are preferably realized in the form of an active functional layer of a flat multilayer gasket that is arranged, for example, between the top and bottom functional layers in order to form an elevation and thusly increase the surface pressure between the flat gasket and the sealing surfaces of the components to be sealed and to prevent the beads for bring pressed flat, namely because pressing flat the beads is associated with the risk of the top and/or bottom functional layer losing the required spring characteristic or tensile strength in the area of the bead or of the cross section to be sealed being reduced. During the installation of a flat gasket with a stopper function layer such as, for example, a MLS-cylinder head gasket, the beads are compressed to the stopper height or until an equilibrium between the bead force absorption and the clamping forces of the flat gasket (e.g., the screw forces) is reached. This means that a stopper essentially defines the installation height of the beads (full beads), and that the function of the stopper consists of limiting the bead deformation by defining the degree of compression of the beads. The typical height of a stopper lies between a few 1/100 mm and about 0.15 mm.

Stopper constructions can be integrated into an active functional layer or serve as a supplementary functional layer between the active functional layers in the form of alpha-stoppers, omega-stoppers, symmetric U-beads with a hard coating, corrugated or trapezoidal stoppers. Furthermore, several of these stopper function layers may also be provided in a flat multilayer gasket. Stopper constructions simultaneously make it possible to achieve a superior topographic adaptation to the adjoining components. In addition, stoppers can be distinguished as follows:
rigid stoppers (e.g., crimped or edge-formed stopper function layer, welded or soldered on/in stopper function layer such as, for example, a stopper ring, etc.);
plastic stoppers (adaptation of the height profile of the flat gasket);
height-profiled or topographic stoppers (height profile adapted during the manufacture), e.g., sintered-on stoppers, purposeful reduction of the substrate in areas of high component rigidity, etc.; and
special stopper geometries, e.g., corrugated stoppers, broad stoppers.

A stopper of different steel qualities, for example, from carbon steel to special steel, can be chosen for flat MLS-gaskets.

Other function layers such as, for example, one or more additional beaded function layers, spacer function layers and/or elastomer function layers may be provided in flat multilayer gaskets such as flat MLS-gaskets.

An elastic/plastic adaptation to the pressure ratios in the chamber or duct to be sealed can be achieved with a corresponding design of spacer function layers that serve as construction elements and variable elements for adapting the installed thickness.

Elastomer function layers preferably can be applied onto active function layers, particularly the top and bottom function layers, in the form of a one-sided or double-sided elastomer coating and ensure the so-called microseal, i.e., the seal against the surface roughness of the sealing surfaces of the components to be sealed or between the function layers of a flat multilayer gasket, respectively. The so-called macroseal is realized with the beads embossed into function layers or the stopper/stoppers realized by means of stopper function layers. Due to a controlled contact pressure, such a coating fills out and compensates any existing roughness, scratch and porosity. The coating of the surfaces has corresponding sliding properties in order to prevent so-called “fretting” marks caused by micromotions under high surface pressure. The function layers may be completely or only partially coated with one layer or several layers or feature one or more special coatings that are adapted, for example, to the extreme demands (high temperatures, significant sliding motions) in predetermined areas. Coatings make it possible to specify a defined flow behavior. For example, a fluoropolymer (with high temperature stability) may serve as elastomer coating.

The function of a flat multilayer gasket with stopper function layer can be suitably described with reference to the example of a MLS-cylinder head gasket with stopper. The universality and transferability of this description to flat multilayer gaskets can be immediately recognized.

A conventional MLS-cylinder head gasket corresponds to the “bead-next-to-stopper” design, i.e., the bead lies behind the stopper relative to the combustion chamber edge. It is therefore arranged in the “secondary non-positive connection.” However, the bead required for sealing the combustion chamber may not only be arranged adjacent to the stopper, but also on the stopper, namely a peripheral stopper rim. This is the case, e.g., in the “Bead-on-Stopper Technology.” In this case, the bead lies in the “primary non-positive connection.” It is advantageous to primarily utilize the introduced screw forces for sealing against the gas. An additional second sealing line can also be realized with a downstream half bead that preferably extends around the combustion chamber. In this construction principle, however, the stopper no longer defines the installed height of the combustion chamber bead.

The stopper of a MLS-cylinder head gasket represents the first sealing stage against combustion gases in the combustion chamber. Due to the prestress of the flat gasket between the sealing surfaces of the components to be sealed, the beads are not used at low to medium interior pressures. The seal in this respect is exclusively realized by prestressing the sealing surfaces of the components to be sealed with the area of the stopper. Once the stopper loses contact as the interior pressure increases, the beads arranged downstream relative to the stopper fulfill the sealing function.

FIGS. 1a to 1f show schematic cross sections through inventive embodiments of a flat gasket. A stopper 30 or a stopper function layer is respectively arranged between the top and bottom function layers 10 and 20. In accordance with the “bead-next-to-stopper” design, a bead 40 or 45 is arranged behind or downstream of the stopper 30 relative to the sealing function with respect to an interior or passage that is encompassed by two components to be sealed relative to one another.

FIGS. 1a to 1d respectively show examples of a downstream half bead 40 while FIGS. 1e and 1f respectively show a downstream full bead 45.

Furthermore, FIGS. 1a to 1f respectively show upstream beads 50 or 55 according to embodiments of the present invention, wherein FIGS. 1a to 1c show an upstream bead in the form of a full bead 50 and FIG. 1f shows an upstream full bead 55.

In addition, different stoppers are schematically illustrated in FIGS. 1a to 1f. FIGS. 1a and 1e, for example, show crimped or edge-formed stopper function layers 30, FIG. 1b shows a stopper 30 arranged on the top function layer 10 (or, although not shown, alternatively on the bottom function layer), FIG. 1c shows an additional function layer 35 that is inserted between the top and bottom function layers, wherein this additional function layer essentially ends, relative to the interior or the passage, flush with the top and bottom function layers 10, and is arranged on a stopper 30, and FIG. 1f shows an additional function layer 35 that is inserted between the top and bottom function layers and features a stopper 30 such as, for example, a stopper ring 30 that is applied/attached, for example, by being welded or soldered onto/on the additional function layer.

It goes without saying that the stopper function layers schematically illustrated in the figures and the top and bottom function layers schematically illustrated in the figures can be combined in any way. As mentioned above, several stopper function layers, as well as one or more additional function layers such as, for example, spacer function layers, coating function layers (not illustrated in the figures) or other function layers, may be provided with one or more beads, wherein additional function layers may also be arranged above and/or underneath the top and bottom function layers, i.e., not only between these layers. In addition, several beads (full and/or half beads) may be arranged upstream and/or downstream. As schematically illustrated in the figures, the top and bottom function layers 10, 20 may be essentially realized (mirror-) symmetrically/congruently, but the top and bottom function layers 10, 20 may also feature one or more different bead types, one or more differently positioned beads and/or a different number of beads.

FIG. 2 shows a schematic horizontal projection of a flat gasket according to an embodiment of the present invention. FIGS. 3a and 3b show sections through the inventive flat gasket according to FIG. 2 along the lines of section indicated in FIG. 2.

FIGS. 3a and 3b show a two-part component with a top component 60 and a bottom component 65 (such as, for example, an engine block 65 and a cylinder head 60), as well as a flat gasket 1 according to an embodiment that is arranged between the components 60 and 65 to be sealed. An opening 70, an interior, a passage, etc., is sealed relative to the sealing surfaces of the components 60 and to be sealed by compressing the flat gasket 1. The compression can be realized, for example, with the aid of screws or other identically or similarly functioning means.

A gas opening 70 represents the opening to be sealed or the interior or passage to be sealed. The escape of gases or mediums situated in the opening, the interior or the passage through an intermediate space formed between the top and bottom components 60 and 65 is at least essentially prevented by the flat gasket 1 arranged and compressed in the intermediate space. Furthermore, an additional opening such as, for example, a gas flow opening 65 may be provided in one of the components 60, 65.

In addition, an insert component 80 is provided in FIGS. 3a and 3b. The insert component 80 may consist, for example, of an insert ring, but may alternatively also have another shape that encompasses the opening, the interior or the passage. In other words, the insert component 80 may be alternatively realized, for example, in an ellipsoidal fashion, but may essentially also have any other shape that encompasses the opening, the interior or the passage.

The insert component 80 may protrude or be recessed relative to the respective sealing surface or essentially end flush with the respective sealing surface. The protrusion or recession of the insert component 80 may be circumferentially variable, i.e., the insert component 80 may be realized with a protrusion in certain areas, a recession in certain areas and flush in certain areas, as well as with any combination thereof. The insert component may have a variable cross section relative to its circumference. The insert component 80 may be provided in one of the components 60 and 65 or in both components 60 and 65. The insert component 80 may be manufactured of the same material as the components 60 and 65 or of another material, preferably a metal such as, for example, spring steel.

The upstream beads 50, 55 may have properties that differ from those of the downstream beads 40, 45. For example, the upstream beads 50, 55 or the bead 50, 55 that comes in contact with the insert part 80 may have a softer bead characteristic. Together with the fact that the insert component 80 may optionally protrude/be recessed relative to the respective sealing surface, this makes it possible to specifically adapt the compression of the upstream bead(s) and therefore its/their sealing effect(s) to a desired demand profile.

The stopper of the inventive flat gasket 1 now no longer is the first sealing stage against mediums/gases in the opening, the interior or the passage to be sealed. In fact, the upstream beads 50, 55 realize the first sealing stage A. The pressure-dependent sealing function of the upstream beads 50, 55 can be adjusted with the aid of the insert component 80 or its protrusion/recession relative to the respective sealing surface. Subsequently, the surface pressure caused by the stopper becomes effective as the second sealing stage B. Once the stopper loses contact as the interior pressure increases, the beads arranged downstream relative to the stopper fulfill the sealing function as a third sealing stage C. Due to the prestress of the flat gasket between the sealing surfaces of the components to be sealed, the downstream beads are not used, e.g., at low to medium interior pressures.

As schematically illustrated in FIG. 3b, it is possible, for example, to realize a “bypass” with the inventive flat gasket 1. In the embodiment shown, the gas flow opening 75 forms a channel that originates at the opening 70, the interior or the passage. The channel of the gas flow opening 75 ends in an area of the respective sealing surface of the component 65, in which the inventive flat gasket 1 is arranged. The channel of the gas flow opening 75 preferably ends in an area of the respective sealing surface of the component 65 that [text missing] a (linear) sealing area of the upstream beads 50, 55 and the (planar) sealing area of the stopper 35. The intensity of the compression of the respective upstream bead 50 and of the insert component 80 can now be adjusted by means of the adjustable protrusion/recession of the insert component 80, i.e., the sealing strength/sealing function of the first beads relative to the respective component 60, 65 with the insert component 80 can be adjusted. Accordingly, the upstream bead loses its sealing function at a predetermined pressure and gas can flow through the channel 75 of the gas flow opening.

1. A flat gasket with at least one beaded layer and one or more stopper function layers, wherein the flat gasket includes at least one peripheral stopper in the stopper function layer around an opening therein to be sealed, wherein at least one first peripheral bead is arranged upstream relative to the sealing function in the at least one beaded layer on a side of the stopper that lies in the direction of the opening to be sealed, wherein at least one second peripheral bead is arranged downstream on the side of the stopper that faces away from the opening to be sealed, and wherein the one or more stopper function layers end before the at least one first peripheral bead in the direction of the opening to be sealed.

2. The flat gasket according to claim 1, wherein the flat gasket consists of a flat multilayer gasket.

3. The flat gasket according to claim 1, wherein the at least one upstream peripheral bead seals relative to at least one insert component provided in at least one sealing surface of an at least two-part component to be sealed, and wherein the sealing function of the at least one upstream peripheral bead is realized by compressing the at least one upstream peripheral bead with a surface of the insert component.

4. The flat gasket according to claim 3, wherein the insert component has a variable or constant protrusion or recession or a combination thereof relative to the respective sealing surface of one part of the two-part component.

5. The flat gasket according to claim 1, wherein the upstream peripheral bead consists of a full bead.

6. The flat gasket according to claim 1, wherein the upstream bead consists of a half bead.

7. The flat gasket according to claim 3, wherein at least one of the parts of the two-part component includes a channel that ends in an area of the sealing surface of the respective component, wherein the area, in which the channel ends, corresponds to an area of the flat gasket between the sealing area of the at least one upstream peripheral bead and the sealing area of the stopper.

8. The flat gasket of claim 2, wherein the multilayer gasket is a multilayer steel gasket.
